(19) United States
(12) Patent Application Publication
(10) Pub. No.: US 2024/0217679 A1
(43) Pub. Date: Jul. 4, 2024

(54) DRONE LED LIGHT SYSTEM

(71) Applicant: Universal City Studios LLC, Universal City, CA (US)

(72) Inventors: Daniel Matthew Freedman, Orlando, FL (US); David Gerard Majdali, Orlando, FL (US)

(21) Appl. No.: 18/090,246

(22) Filed: Dec. 28, 2022

(51) Int. Cl. B64U 10/60; B64C 39/02; B64D 47/00; B64U 20/80; B64U 50/13; G05D 1/10

(52) U.S. Cl. CPC B64U 10/60; B64C 39/024; B64D 47/00; B64U 20/80; B64U 50/13; G05D 1/104; B64D 2203/00

(57) ABSTRACT

An aerial drone system includes a first drone comprising a first drone body and a first propeller system configured to propel the first drone through air, a second drone comprising a second drone body and a second propeller system configured to propel the second drone through the air, and an electronic media tether coupled to the first drone and the second drone, wherein the electronic media tether includes a plurality of light emitting diodes (LEDs) and is configured to transmit power to the plurality of LEDs.

### BACKGROUND

The present disclosure relates generally to the field of amusement parks. More specifically, embodiments of the present disclosure relate to methods and equipment utilized to provide amusement park experiences.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks often contain attractions or experiences that use fireworks, drones (e.g. unmanned aerial vehicles), and/or videos, to provide enjoyment and entertain guests of amusement parks. For example, light shows may be performed by a group of drones that may independently arrange themselves into various aerial formations. For some light shows, it may be desirable to display the light show more intricately and cover a large area of the sky. The more intricate the light show, the more drones are needed to create the aerial images. Indeed, the light show may need to utilize hundreds or thousands of drones to create a cohesive aerial image in the sky. As such, utilizing many drones and displaying light shows may be challenging due to the number of drones that may be used to create the aerial image in the sky, cost, equipment availability, and complexity, for example. Thus, improvements for creating light shows using drones are desired to provide simplicity, efficiency, and/or a more desirable interactive experience.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with an embodiment, an aerial drone system includes a first drone comprising a first drone body and a first propeller system configured to propel the first drone through air, a second drone comprising a second drone body and a second propeller system configured to propel the second drone through the air, and an electronic media tether coupled to the first drone and the second drone, where the electronic media tether includes a plurality of light emitting diodes (LEDs) and is configured to transmit power to the plurality of LEDs.

In accordance with an embodiment, an aerial drone system includes a mesh of electronic media line. The mesh of electronic media line includes a plurality of LEDs extending along the mesh. The aerial drone system also includes a plurality of propeller drones configured to fly in air and coupled together via the mesh of electronic media line. Moreover, the aerial drone system includes a control system including memory and one or more processors, wherein the memory stores instructions that are configured to be executed by the one or more processors to cause the one or more processors to instruct the plurality of drones to fly in a pattern to form a desired shape with the mesh of electronic media line.

In accordance with an embodiment, a method of an aerial drone system operation includes steps of defining a flight pattern based on a desired shape for an electronic media tether and based on a desired stereophonic arrangement of speakers disposed along the electronic media tether, flying a plurality of drones coupled together via the electronic media tether in the flight pattern, and controlling the power through the electronic media tether to operate light emitting diodes disposed along the electronic media tether and the speakers disposed along the electronic media tether.

### BRIEF DESCRIPTION OF THE DRAWINGS

Certain embodiments commensurate in scope with the originally claimed subject matter are summarized below. These embodiments are not intended to limit the scope of the claimed subject matter, but rather these embodiments are intended only to provide a brief summary of possible forms of subject matter. Indeed, the subject matter may encompass a variety of forms that may be similar to or different from the embodiments set forth below.

FIG. 1 is a block diagram of an aerial drone system in accordance with aspects of the present disclosure;

FIG. 2 is a perspective view of a first drone, a second drone, and an electronic media tether in accordance with aspects of the present disclosure;

FIG. 3 is a perspective view of a fleet of drones creating a shape with electronic media tethers in accordance with aspects of the present disclosure;

FIG. 4 is a perspective view of the first drone, the second drone, and the electronic media tether including a mesh in accordance with aspects of the present disclosure;

FIG. 5 is a perspective view of the fleet of drones creating a shape including the mesh of the electronic media tether in accordance with aspects of the present disclosure; and

FIG. 6 is a perspective view of the fleet of drones coupled together via the electronic media tether and speakers disposed along the electronic media tether in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Light shows at amusement parks have become increasingly popular, and various amusement parks have been utilizing drones to create unique visual experiences for park guests. As light shows increase in popularity, a need for reusable light-bearing drones is believed to also be increasing because they are safer, quieter, simpler, and more customizable than other options (e.g., fireworks). Large quantities of drones may be needed to display a more complex aerial image, such as an image formed from numerous light points (e.g., a single drone with onboard lighting). Generally, an increase in desired lighting (e.g., points of light) for a particular display may be costly because traditionally there is a one-to-one ratio between number of light points and number of individual drones. Additionally, more time may be necessary to set up and fly the drones. For example, a programmer may have to spend more time programming the various movements of a large number of drones than if they were programming a smaller number.

With the foregoing in mind, this disclosure is directed to an aerial drone system for creating an aerial display using drones. Relative to traditional operations, the aerial drone system reduces a number of drones needed to create intricate aerial images while reducing associated costs and complexity of implementation of drone light shows in amusement parks. The present disclosure describes various embodiments that include an aerial drone system that may include a plurality of drones with an electronic media tether including a plurality of light emitters (e.g., LEDs) coupled to each drone. A control system may instruct the plurality of drones to move to aerial positions while taking into account characteristics (e.g., positioning of the media tether, articulation of the media tether, light emitter and/or audio emitter positioning along the media tether). In this manner, the electronic media tether coupled to each drone may be used to create light point-based aerial formations (e.g., shapes, designs, and so on) in the sky and/or audio landscapes. As such, the light effect of the electronic media tethers may enhance the appearance of the light show, provide more simplicity in execution, and create a unique experience for amusement park guests. Further, audio features can be employed to facilitate a more immersive experience for observers. Additional details with regard to the aerial drone system and embodiments in which the aerial drone system may present aerial light shows and audio to an amusement park guest will be discussed below.

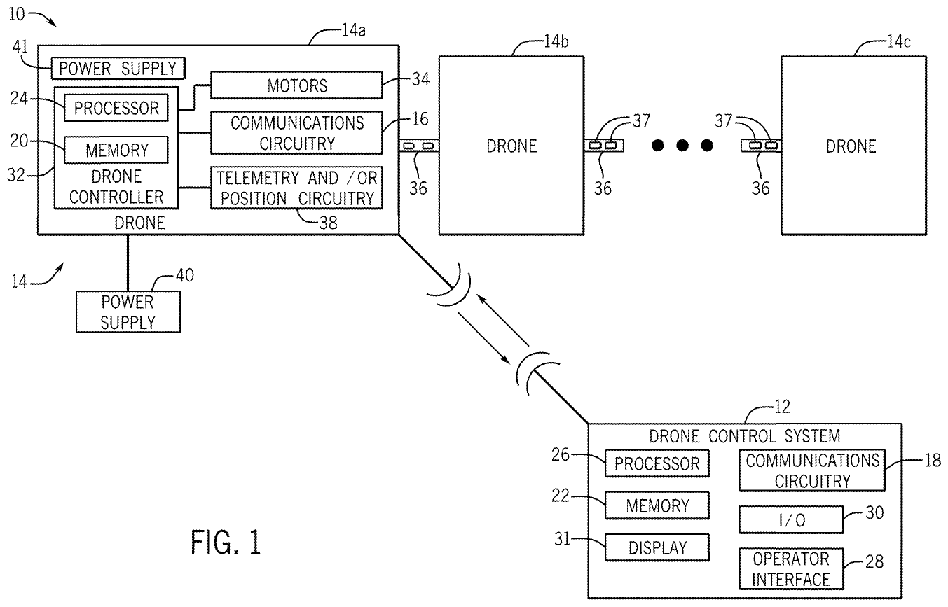

By way of introduction, FIG. 1 is a block diagram of an aerial drone system 10, in accordance with the present disclosure. The aerial drone system 10 may include a fleet of drones 14 (e.g., single rotor drones, multi-rotor drones, quadcopters, and so on) and a drone control system 12 configured to send instructions to the fleet of drones 14. In the illustrated embodiment, the fleet of drones 14 includes three drones 14a, 14b, 14c that are representative of any number of drones. The fleet of drones 14 and the drone control system 12 include communications circuitry (e.g. onboard communications circuitry 16 and offboard communications circuitry 18), such as antennas, radio transceiver circuits, and signal processing hardware and/or software (e.g., hardware or software filters, A/D converters, multiplexers amplifiers), or a combination thereof, and that may be configured to communicate over wireless communication paths via Infrared (IR) wireless communication, satellite communication, broadcast radio, Microwave radio, Bluetooth, Zigbee, Wi-fi, UHF, NFC, etc.

Additionally, one or both of the fleet of drones 14 and the drone control system 12 may include a memory device (e.g., onboard memory device 20 and/or offboard memory device 22) for storing instructions executable by one or more processors (e.g., onboard processor 24 and/or offboard processor 26) to perform the methods and control actions described herein. The processor may include one or more processing devices, and the memory may include one or more tangible, non-transitory, machine-readable media. The memory may include volatile memory, such as random access memory (RAM), and/or non-volatile memory, such as read-only memory (ROM), optical drives, hard disc drives, solid-state drives, or any other non-transitory computer-readable medium that includes instructions. For example, the drone control system 12 may be accessed by an operator interface 28 (e.g., a computer-based workstation or a mobile device), and/or may include an input/output interface 30 and a display 31. In one example, the display 31 may be a touch display capable of receiving inputs from a user. While the drone control system 12 may be implemented as a separate device or devices from the fleet of drones 14, it should be understood that certain functionality disclosed as part of the drone control system 12 may be additionally or alternatively implemented within the fleet of drones 14.

As illustrated, the fleet of drones 14 may contain at least one drone controller 32 that controls the execution of a flight plan or flight path for the fleet of drones 14. With respect to controlling flight plan or flight path execution, a single drone (e.g., drone 14a in the illustrated embodiment) may include the drone controller 32 and manage additional drones (e.g., drones 14b, 14c) that do not have their own drone controller. For example, in an embodiment, the drone 14a may be a master drone with the communications circuitry 16, the memory 20, and the processor 24, and may send instructions to drones 14b, 14c (which represent any number of drones) to execute the flight plans. This arrangement may be facilitated by communication between the drones 14a, 14b, 14c over electronic media tethers 36 communicatively coupling the drones 14a, 14b, 14c together. However, in a different embodiment, each drone 14a, 14b, 14c of the fleet of drones 14 may include a respective version or aspect of the drone controller 32 to facilitate coordination amongst the fleet of drones 14. More specifically, for example, each drone of the fleet of drones 14, may include a version or aspect of the drone controller 32 with the communications circuitry 16, the memory 20, and the processor 24, and may each individually execute flight plans and communicate back and forth. The flight plan may be communicated from the drone control system 12 (e.g., in real-time) or may be pre-programmed and stored in the onboard memory 20 and/or offboard the memory 22. Further, in certain embodiments, operator input may be implemented in real-time to generate a flight plan and/or may override previous flight plan instructions. The drone controller 32 controls the operation of motors 34 and other flight components of the fleet of drones 14 to execute the desired flight plan.

The aerial drone system 10 may also include electronic media tethers 36 which may include an electronic media tether, electronic media line, cable, cord, power strip, or LED strip coupled to each drone (e.g., drones 14a, 14b, 14c) of the fleet of drones 14. The electronic media tethers 36 may facilitate electronic communication with and between individual drones (e.g., drones 14a, 14b, 14c) of the fleet of drones 14. In the present disclosure, the electronic media tethers 36 may include LEDs and/or speakers. The electronic media tethers 36 may be one single unit coupled to each drone or multiple units designed to couple each drone to another drone. In an embodiment, the electronic media tethers 36 may include a plurality of rigid segments serially attached together via articulating couplings. In another embodiment, the electronic media tethers 36 may be flexible to allow for an additional range of motion and the creation of shapes. The electronic media tethers 36 may include a plurality of LEDs that may emit light of various and/or changing types (e.g., steady light, changing light characteristics, or blinking light of the same or multiple colors). Further, the electronic media tethers 36 may be coupled to a power source 40 that is configured to give power to the fleet of drones 14. For example, the power source may be an electrical connection to the power source 40 external to the fleet of drones 14. Each drone may include its own power supply 41, such as a battery, which may operate independently or receive power via the electronic media tethers 36 (e.g., from the power source 40). In addition to providing power, the electronic media tethers 36 may facilitate communication, via a communication bus, between each member of the fleet of drones 14, which may improve the timing of communication and reduce latency. In some embodiments, the electronic media tethers 36 may also include speakers to provide sound, such as stereophonic sound, including surround sound, to guests in the amusement park.

The fleet of drones 14 may also include telemetry and/or position circuitry 38 (e.g., positioning sensors) to provide navigation or guidance information to the drone control system 12 to use as feedback for determining whether the aerial display is being displayed as intended. Accordingly, the fleet of drones 14 may use location information determined by the telemetry and/or position circuitry 38, such as GPS information accessed from a GPS chip, triangulation information from radio communication, and/or feedback from one or more cameras, position sensors, or proximity sensors on the fleet of drones 14. For example, the telemetry and/or position circuitry may be used to determine a drone in the fleet of drones 14 is in the wrong position based on its geographic location or GPS coordinates and is thus not displaying the proper aerial image. Telemetry and/or position circuitry 38 may also provide feedback to keep the fleet of drones 14 outside a particular boundary to prevent guest interference with the drones.

In some embodiments, the aerial drone system 10 may include the fleet of drones 14 coupled together via the electronic media tethers 36 in the form of a mesh (e.g. interwoven or intertwined material). The mesh may include a plurality of LEDs extending along the material. The fleet of drones 14 may be instructed by the drone control system 12 to fly in a pattern to form the desired shape with the mesh. In response to the instructions, the fleet of drones 14 may fly in accordance with the pattern to form the desired shape and create an aerial display. In this manner, relative to traditional operations, more intricate and dynamic shapes may be created while utilizing a smaller number of drones.

In some embodiments, the aerial drone system 10 may include the fleet of drones 14 with the electronic media tethers 36 coupled to each drone, where the electronic media tethers 36 include LEDs and speakers. The fleet of drones 14 may be instructed to fly in a flight pattern based on a desired shape and to create a desired sound landscape (e.g., surround sound) for guests. As such, in response to the instructions, the fleet of drones 14 may fly in accordance with the pattern to create the desired shape and provide a more immersive experience for guests using surround sound.

The aerial drone system 10 may execute instructions from the drone control system 12 or the drone controller 32 to define a first aerial position and then a second aerial position based on a desired shape of the electronic media tether 36. For example, the aerial drone system 10 may position the fleet of drones 14 to provide a square shape (first aerial position) and then a triangle shape (second aerial position) of the media tether 36. The aerial drone system 10 may include position circuitry 38 (e.g., a first positioning sensor on a first drone and a second positioning sensor on a second drone) and the drone control system 12 and/or the drone controller 32 may operate based on instruction to identify desired locations for the first drone and the second drone, define the first aerial position and the second aerial position based on the desired locations, and confirm the first drone and the second drone are in the desired locations based on feedback from the first positioning sensor and the second positioning sensor. As can be appreciated, this can apply to any number of drones. For example, a third drone coupled to the first and second drones referenced in the example above may facilitate additional shape-forming options.

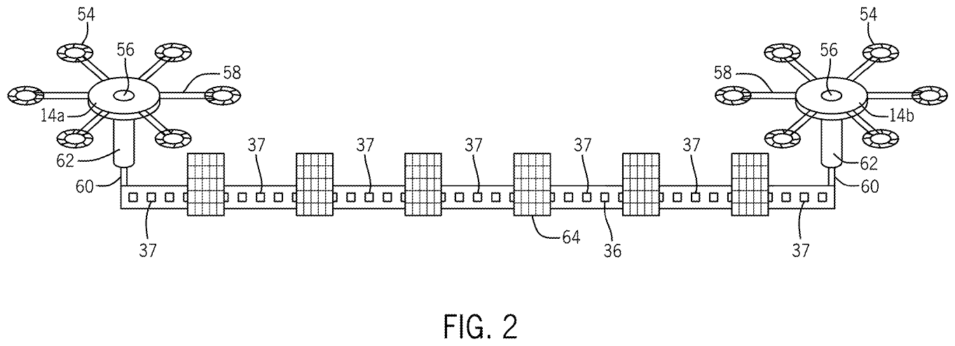

FIG. 2 is a perspective view of a first drone 14a, a second drone 14b, and the electronic media tether 36. The first drone 14a and the second drone 14b may include propellers 54 coupled to a body 56 by struts 58. The electronic media tether 36 may be coupled to each of the first drone 14a and the second drone 14b via a respective coupler 60 (e.g., an offsetting rigid connection or a component of a body of the drone). The coupler 60, which may be capable of articulation (e.g., may include articulation joints and controlled actuators to activate articulation), may enable an extension to create distance between the drone and the electronic media tether 36 which may prevent entanglement. In some embodiments, the coupler 60 (e.g. offsetting rigid component) may extend away from the first drone body 56 transversely to an axis of rotation of a propeller 54 of a first propeller system. As disclosed herein, the electronic media tether 36 includes the plurality of LEDs and/or a plurality of speakers 64. As illustrated, the electronic media tether 36 is positioned on an underside of the first drone 14a and the second drone 14b. However, other orientations are also contemplated. Indeed, in an embodiment having an articulable version of the coupler 60, orientation can be dynamic (e.g., changed prior to or even during flight). It should be noted that any drone described herein may include some or all of the same components as the first drone 14a and the second drone 14b.

In some embodiments, the electronic media tether 36 may be coupled and uncoupled from each drone of the fleet of drones 14 by an operator. For example, the first drone 14a and second drone 14b may be fully modular such that the electronic media tether 36 and other components (e.g., a controller) may be removed from the first drone 14a and the second drone 14b by an operator and replaced by another electronic media tether 36. In another embodiment, the first drone 14a and second drone 14b may be partially modular, whereby a controller (e.g., controller 32, see FIG. 1) is housed within a base 62 of the respective drone (e.g., first drone 14a or second drone 14b) and the coupler 60 is removable and replaceable. In yet another embodiment, the electronic media tether 36 may include the plurality of LEDs and the plurality of speakers 64. In some embodiments, one or more drones (e.g., the second drone 14b) may be designed to decouple from the electronic media tether 36 during flight or operation. For example, to achieve a particular desired visual effect, the drone 14a could retain a connection with the electronic media tether 36 while the drone 14b decouples from the media tether 36, allowing it to drop.

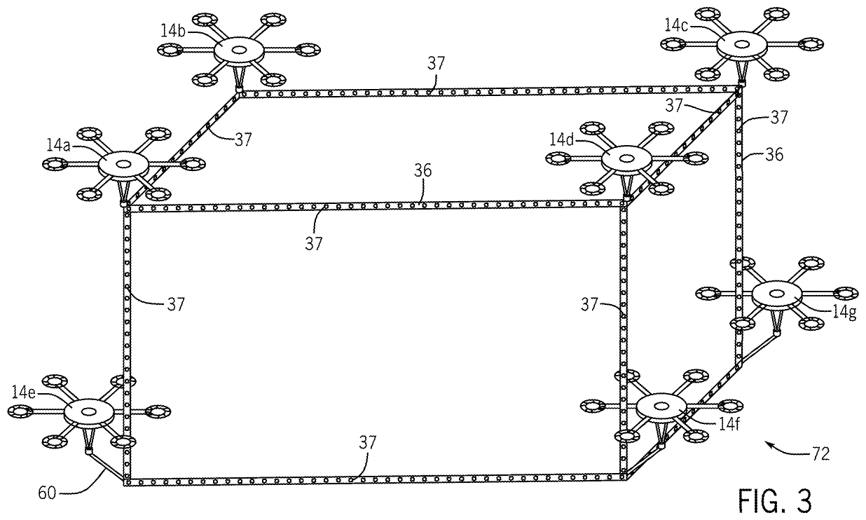

As provided herein, a fleet of drones 14 may operate to execute a flight plan to provide a coordinated aerial display at a desired location and a desired time. FIG. 3 is a perspective view of a fleet of drones 14 (e.g., 14a, 14b, 14c, 14d, 14e, 14f, 14g) creating a shape 72. The fleet of drones may each include the electronic media tethers 36 coupled to each drone of the fleet of drones 14. The electronic media tether 36 may be a single electronic media tether line that may couple each drone of the fleet of drones 14 to one another at a predetermined distance along the length of the single tether of the electronic media tether 36. In some embodiments, each drone of the fleet of drones 14 may be coupled to two or more drones of the fleet of drones 14. As such, each drone of the fleet of drones 14 may have a single electronic media tether 36 coupled to the coupler 60 or multiple electronic media tethers 36 coupled to the coupler 60. When instructed, the fleet of drones 14 may create the aerial display, which may consist of various shapes, configurations, structures, or sizes. In an embodiment, the shape 72 created by an aerial formation of the fleet of drones 14 may be two-dimensional (2D). In another embodiment, the shape 72 created by the aerial formation of the fleet of drones 14 may be three-dimensional (3D). In the illustrated example, the shape 72 is that of a 3D cube in the sky that may be seen by the guests of an amusement park. The shape 72 is created by the electronic media tethers 36 coupled to each drone of the fleet of drones 14. The electronic media tethers 36 may each include a plurality of LEDs that may emit light of various and/or changing types. For example, the plurality of LEDs on the electronic media tethers 36, which may be positioned to create the shape 72, may each be a first color (e.g., red). The plurality of LEDs on the electronic media tethers 36 may then transition to a second color (e.g., blue) when instructed to by the drone control system 12. Further, the electronic media tethers 36 may emit steady light, transitioning light or a blinking light of the same or multiple colors. In this manner, the guests of the amusement park can experience an aerial display of various colors and effects. It should be noted that the fleet of drones 14 may operate in the same manner as described in FIG. 1.

As disclosed herein, each drone of the fleet of drones 14 may move in any direction to create the aerial display. The drone control system 12 (FIG. 1) may determine desired locations for each drone of the fleet of drones 14 and may send instructions to a single drone or each drone of the fleet of drones 14 to execute a flight plan. A single drone may have the drone controller 32 and may manage the execution of the flight plan or flight path for the fleet of drones 14 that do not have their own controller. Alternatively, each drone 14a, 14b, 14c, 14d, 14e, 14f, and 14g of the fleet of drones 14 may include a respective version or aspect of the drone controller 32 to facilitate coordination amongst the fleet of drones 14. In some embodiments, the fleet of drones 14 may be instructed create a first shape and subsequently change aerial formation to create a second shape. In an embodiment, the fleet of drones 14 may be instructed to fly to create multiple subsequent shapes using the aerial formation. As such, the fleet of drones 14 may transition into various shapes and/or configurations, and the plurality of LEDs may display different colors to create the aerial display. The drone control system 12 may use the telemetry and/or position circuitry 38 (FIG. 1) to verify that each drone of the fleet of drones 14 is in the proper position based on the geographic location or GPS coordinates of each drone of the fleet of drones 14 and is thus displaying the aerial image as instructed. Moreover, the electronic media tethers 36 may be coupled to the power source 40 (FIG. 1) that is configured to give power to the fleet of drones 14. The control system 12 has or generates a mapped relationship of the fleet of drones 14 and the electronic media tethers 36. The control system 12 takes this mapped relationship into account when instructing the fleet of drones 14 to maneuver so that tangling and interference between the electronic media tethers 36, the individual drones (e.g., drones 14a, 14b, 14c) in the fleet of drones 14, or both do not interfere with each other or become tangled.

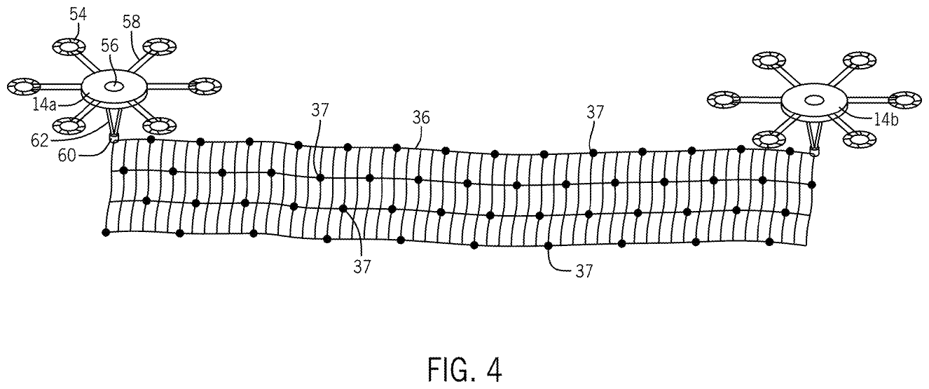

FIG. 4 is a perspective view of the first drone 14a, the second drone 14b, and the electronic media tether 36. The electronic media tether 36 is coupled to the first drone 14a and the second drone 14b via the coupler (offsetting rigid coupling) 60. As disclosed herein, the electronic media tether 36 may be in the form of a mesh and may include the plurality of LEDs (FIG. 2) and/or the plurality of speakers 64 (FIG. 2) extended along the mesh. As illustrated, the electronic media tether 36 is positioned on an underside of the first drone 14a and the second drone 14b. However, other orientations are also contemplated. It should be noted that any drone described herein may include some or all of the same components as the first drone 14a and the second drone 14b. In some embodiments, the electronic media tether 36 may be coupled and uncoupled from each drone of the fleet of drones 14 by an operator.

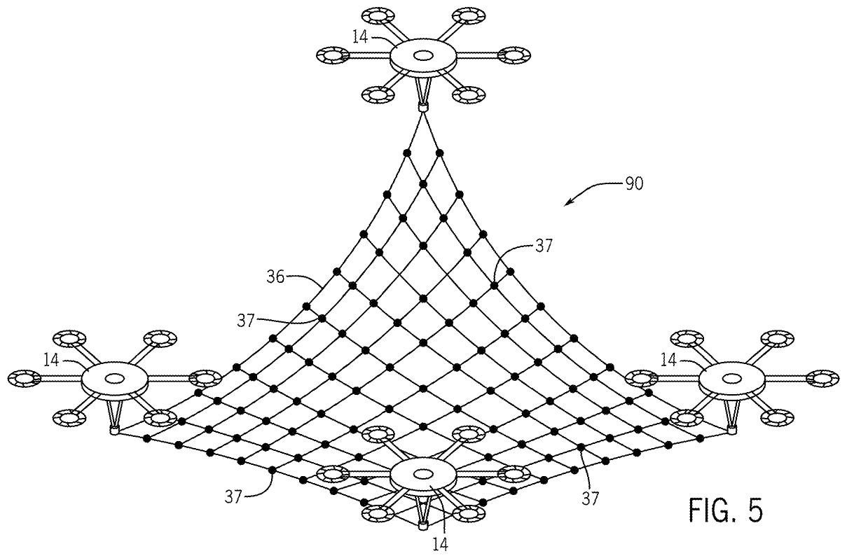

The fleet of drones 14 may operate to execute a flight plan to provide a coordinated aerial display at a desired location and a desired time. FIG. 5 is a perspective view of a fleet of drones 14 creating a shape 90. As an example, the shape 90 may represent a cone or pyramid. The fleet of drones may include the electronic media tethers 36 coupled to each drone of the fleet of drones 14. When operated, the fleet of drones 14 may create the aerial display which may consist of various shapes, configurations, structures, or sizes using the electronic media tethers 36 which may include the mesh. It should be noted that the fleet of drones may operate in the same manner as described in FIG. 1.

In operation, the fleet of drones 14 may include the electronic media tethers 36 coupled to each drone. Each member of the fleet of drones 14 may be instructed, by the drone control system 12 (FIG. 1), to fly to a respective aerial position (e.g., move from a first aerial position to a second aerial position) to create the shape 90 in the sky using the electronic media tethers 36, which may include the mesh. The fleet of drones 14 may fly to extend the electronic media tethers 36 which may include the mesh into various shapes and configurations (e.g., moving from a first aerial position to a second aerial position and then to a third aerial position). In the illustrated example, the fleet of drones 14 have been instructed to fly to create the shape of a cone. In an embodiment, the fleet of drones 14 may include peripheral drones coupled to the peripheral edges of the mesh of the electronic media tethers 36. Further, at least one drone 14 of the fleet of drones 14 may be a central drone coupled to a central portion of the mesh of the electronic media tethers 36. As disclosed herein, the plurality of LEDs extending along the electronic media tethers 36 (including a mesh in the illustrated embodiment) may emit steady light, transitioning light or a blinking light of the same or multiple colors. In some embodiments, the fleet of drones 14 may be instructed to create a first shape and subsequently change aerial formation to create a second shape. It should be noted that the fleet of drones 14 may be instructed to fly to specific aerial positions to create multiple subsequent shapes using the aerial formation. Indeed, the fleet of drones 14 may transition into various shapes and/or configurations, and the plurality of LEDs may display multiple colors to create the aerial display using the electronic media tethers 36 which may include the mesh. The drone control system 12 may use the telemetry and/or position circuitry 38 (FIG. 1) to verify that each drone of the fleet of drones 14 is in the proper position based on the geographic location or GPS coordinates of each drone of the fleet of drones 14 and is thus displaying the aerial image as instructed.

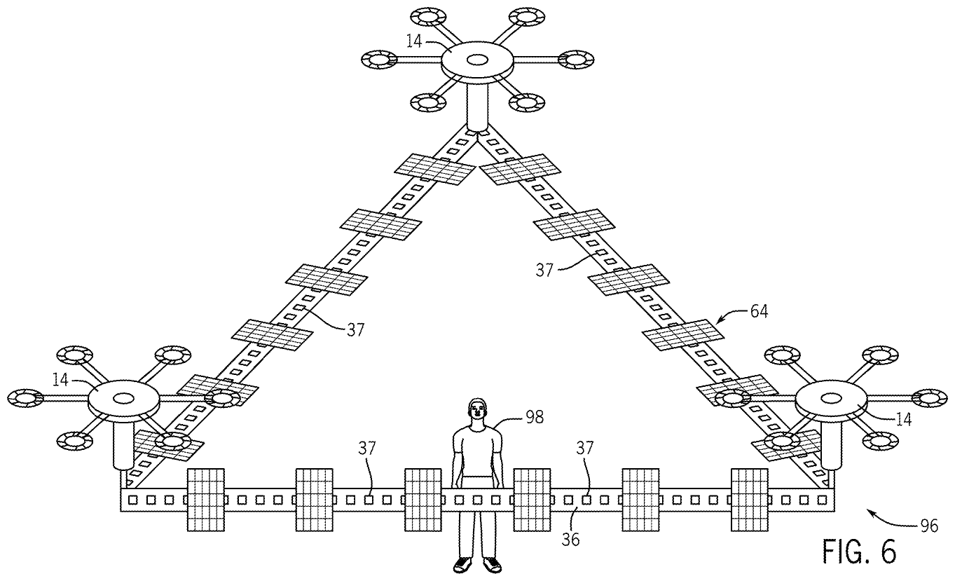

FIG. 6 is a perspective view of a fleet of drones 14 coupled together via the electronic media tether 36 and the plurality of speakers 64 disposed along the electronic media tether 36. As illustrated, each drone of the fleet of drones 14 is coupled via the electronic media tether 36 including the plurality of LEDs and the plurality of speakers 64. The electronic media tethers 36 including the plurality of LEDs and the plurality of speakers 64 may be coupled to the power source 40 (FIG. 1) that is configured to give power to the fleet of drones 14, as well as the plurality of LEDs and the plurality of speakers 64.

The aerial drone system 10 may execute instructions from the drone control system 12 or the drone controller 32 to define a first aerial position and then a second aerial position to establish a stereophonic arrangement configured to provide stereophonic sound at an observation location from the plurality of speakers 64. A flight pattern may be defined based on a desired shape for the electronic media tethers 36 and based on a desired stereophonic arrangement of speakers 64 disposed along the electronic media tethers 36. For example, the aerial drone system 10 may position the fleet of drones 14 to provide a circular shape (first aerial position) around a guest 98 and then a square shape (second aerial position) for providing stereophonic sound at the observation location of the guest 98.

In operation, the drone control system 12 (FIG. 1) may send instructions to the fleet of drones 14 to move to an aerial position to enable the fleet of drones 14 to provide the aerial display and a surround sound speaker arrangement 96 to the guest 98 in the observation location. In this manner, the fleet of drones 14 may provide the aerial display to the guest 98 while simultaneously providing audio to the guest 98. In some embodiments, the audio produced by the plurality of speakers 64 and heard by the guest 98 may be a composition of sounds produced by various speakers of the plurality of speakers 64. That is, each speaker of the plurality of speakers 64 may be instructed to produce a different sound that, when combined with sounds produced by other speakers of the plurality of speakers 64, may form a surround sound audio environment or a specifically desired soundscape. Moreover, the plurality of speakers 64 may be configured to produce audio in a manner that provides a custom audio to each guest 98. Present embodiments may utilize tracking equipment (e.g., GPS, cameras, RFID) to track a position of the guest 98 and may control positioning of individual drones of the fleet of drones 14, taking into account positioning of the speakers 64 between individual drones and along the electronic media tether 36 to achieve the desired soundscape (e.g., surround sound).

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An aerial drone system, comprising:
a first drone comprising a first drone body and a first propeller system configured to propel the first drone through air;
a second drone comprising a second drone body and a second propeller system configured to propel the second drone through the air; and
an electronic media tether coupled to the first drone and the second drone, wherein the electronic media tether comprises a plurality of light emitting diodes (LEDs) and is configured to transmit power to the plurality of LEDs.

2. The aerial drone system of claim 1, comprising:
a control system including memory and one or more processors, wherein the memory stores instructions that are configured to be executed by the one or more processors to cause the one or more processors to instruct the first drone to move to a first aerial position and instruct the second drone to move to a second aerial position.

3. The aerial drone system of claim 2, wherein the instructions are configured to be executed by the one or more processors to define the first aerial position and the second aerial position based on a desired shape of the electronic media tether.

4. The aerial drone system of claim 2, comprising a first positioning sensor on the first drone and a second positioning sensor on the second drone, wherein the instructions are configured to be executed by the one or more processors to:
identify desired locations for the first drone and the second drone;
define the first aerial position and the second aerial position based on the desired locations; and
confirm the first drone and the second drone are in the desired locations based on feedback from the first positioning sensor and the second positioning sensor.

5. The aerial drone system of claim 1, comprising:
a third drone comprising a third drone body and a third propeller system configured to propel the third drone through the air; and
an additional electronic media tether coupling the third drone to the first drone.

6. The aerial drone system of claim 1, comprising:
a third drone comprising a third drone body and a third propeller system configured to propel the third drone through the air, wherein the electronic media tether couples the third drone to the first drone.

7. The aerial drone system of claim 6, wherein the electronic media tether couples the third drone to the second drone.

8. The aerial drone system of claim 7, wherein the electronic media tether comprises separate tether segments configured to detachably couple with the first drone, the second drone, and/or the third drone.

9. The aerial drone system of claim 7, comprising:
a control system including memory and one or more processors, wherein the memory stores instructions; and
wherein the instructions are configured to be executed by the one or more processors to define a first aerial position and a second aerial position based on a desired shape of the electronic media tether.

10. The aerial drone system of claim 1, wherein the electronic media tether comprises a plurality of rigid segments serially attached together via articulating couplings.

11. The aerial drone system of claim 1, wherein the electronic media tether comprises a plurality of speakers and is configured to transmit the power to the plurality of speakers.

12. The aerial drone system of claim 11, comprising:
a control system including memory and one or more processors, wherein the memory stores instructions that are configured to be executed by the one or more processors to:
cause the one or more processors to instruct the first drone to move to a first aerial position and instruct the second drone to move to a second aerial position; and
define the first aerial position and the second aerial position to establish a stereophonic arrangement configured to provide stereophonic sound at an observation location from the plurality of speakers.

13. The aerial drone system of claim 12, wherein the stereophonic arrangement is configured to provide surround sound at the observation location from the plurality of speakers.

14. The aerial drone system of claim 1, wherein the electronic media tether comprises an LED strip configured to receive the power from the first drone, the second drone, or both, and wherein the power is transmitted from a power supply.

15. The aerial drone system of claim 1, comprising a plurality of drones coupled together via segments of the electronic media tether, wherein a single drone of the plurality of drones is configured to communicate via the electronic media tether to control flight patterns of the plurality of drones, and wherein the first drone and the second drone are part of the plurality of drones.

16. The aerial drone system of claim 1, wherein the first drone comprises a rigid offset coupled to the electronic media tether, wherein the rigid offset extends away from the first drone body transversely to an axis of rotation of a propeller of the first propeller system.

17. An aerial drone system, comprising:
a mesh of electronic media line including a plurality of light emitting diodes (LEDs) extending along the mesh;
a plurality of propeller drones configured to fly in air and coupled together via the mesh of electronic media line; and
a control system including memory and one or more processors, wherein the memory stores instructions that are configured to be executed by the one or more processors to cause the one or more processors to instruct the plurality of drones to fly in a pattern to form a desired shape with the mesh of electronic media line.

18. The aerial drone system of claim 17, wherein the plurality of drones comprise:
peripheral drones coupled to peripheral edges of the mesh of the electronic media line; and
at least one central drone coupled to a central portion of the mesh of the electronic media line.

19. A method of aerial drone system operation, comprising:
defining, via a control system, a flight pattern based on a desired shape for an electronic media tether and based on a desired stereophonic arrangement of speakers disposed along the electronic media tether;
flying, via the control system, a plurality of drones coupled together via the electronic media tether in the flight pattern; and
controlling power, via the control system, through the electronic media tether to operate light emitting diodes disposed along the electronic media tether and the speakers disposed along the electronic media tether.

20. The method of claim 19, comprising:
instructing, using one or more processors, the plurality of drones to fly in the flight pattern based on the desired stereophonic arrangement of speakers; and
instructing, using the one or more processors, the speakers to provide stereophonic sound at an observation location from the speakers.
